(19) United States
(12) Patent Application Publication
(10) Pub. No.: US 2005/0159135 A1
(43) Pub. Date: Jul. 21, 2005

(54) System and method for making a multimedia message service compatible with non-supported terminals

(75) Inventor: Young-Ae Kim, Seoul (KR)

Correspondence Address: JONATHAN Y. KANG, ESQ.;LEE, HONG, DEGERMAN, KANG & SCHMADEKA, P.C., 801 S. Figueroa Street, 14th Floor, Los Angeles, CA, 90017, US

(73) Assignee: LG Electronics Inc.

(21) Appl. No.: 11/040,584

(22) Filed: Jan. 20, 2005

(30) Foreign Application Priority Data
Jan. 20, 2004 (KR) 04538/2004
Dec. 24, 2004 (KR) 112287/2004

(51) Int. Cl. H04Q 7/20

(52) U.S. Cl. 455/410

(57) ABSTRACT

A system and method for making a multimedia message service compatible with a non-supported multimedia message terminal. The system comprising a first system for converting a format of a multimedia message and transmitting a uniform resource locator and an access code of the converted multimedia message in response to a receiving terminal being detected as the non-supported multimedia message terminal. A second system for receiving the converted multimedia message, and transmitting the uniform resource locator and the access code to the non-supported multimedia terminal. The non-supported multimedia terminal receives the converted multimedia message.

### CROSS-REFERENCE TO RELATED APPLICATIONS

Pursuant to 35 U.S.C. § 119(a), this application claims the benefit of earlier filing date and right of priority to Korean Application No. 10-2004-004538, filed on Jan. 20, 2004, and Korean Application No. 10-2004-0112287, filed on Dec. 24, 2004, contents of which are hereby incorporated by reference herein in their entirety.

### BACKGROUND OF THE INVENTION

1. Field of the Invention

The present invention relates to a system and method for making a multimedia message service compatible with terminals not supported by a multimedia message service.

2. Description of the Related Art

A mobile terminal provides multimedia access, internet access, voice transmission, and data transmission. The mobile terminal may have a camera for transmitting and/or receiving image shots from other mobile terminals.

A multimedia message service (MMS) is a message service for adding a visual or audible factor to a text-based short message, transmitting video, and combining images or background music together with a text message.

As the interests of users of MMS are increasing, demands for a supported MMS terminal are growing faster relative to non-supported MMS terminals providing only a short message service (SMS).

A related art non-supported MMS terminal will receive notification that a multimedia message was created by a MMS terminal. A user of a non-supported MMS terminal will only receive notification that a multimedia message was transmitted. A user of a non-supported MMS terminal accesses the multimedia message using a personal computer. The personal computer is required to connect to a web server in which the multimedia message was stored. Users of non-supported MMS terminals are inconvenienced because these users cannot view multimedia message from their terminals.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In one embodiment, a system for making a multimedia message service compatible with a non-supported multimedia message terminal is disclosed. The system comprises a first system for converting a format of a multimedia message and transmitting a uniform resource locator and an access code of the converted multimedia message in response to a receiving terminal being detected as the non-supported multimedia message terminal.

A second system is also provided for receiving the converted multimedia message, and transmitting the uniform resource locator and the access code to the non-supported multimedia message terminal. The non-supported multimedia message terminal receives the converted multimedia message.

A wireless application protocol gateway may be provided for transmitting a request for the multimedia message and the converted multimedia message between the first system and the non-supported multimedia message terminal.

A home location register may be provided for storing specific information of terminals connected to the first system. The specific information preferably comprises at least one of a mobile station integrated system digital network and a mobile identification number.

The first system preferably comprises a transmission/reception unit for communicating a multimedia message and information about the multimedia message, a conversion unit for converting the multimedia message into a format capable of being implemented by the receiving terminal, and a storage unit for storing the multimedia message and the converted multimedia message. An access code generation unit may be provided for generating an access code permitting access to the uniform resource locator of the converted multimedia message and storing the converted multimedia message, an information monitoring service unit for monitoring programs implemented in the receiving terminal, a notification unit for informing the receiving terminal regarding arrival of the multimedia message, and an authentication unit for performing authentication when accessing the uniform resource locator associated with the converted multimedia message.

In yet another embodiment, a method is disclosed for making a multimedia message service compatible for transmitting a multimedia message to a receiving terminal. The method comprises determining if the receiving terminal is an non-supported multimedia message terminal, converting a multimedia message by a first system into a format supportable in the receiving terminal in response to the receiving terminal being detected as a non-supported multimedia message terminal, informing the receiving terminal of a uniform resource locator and an access code of the converted multimedia message through a second system.

The method further comprises the receiving terminal requesting the multimedia message stored in the uniform resource locator through a wireless application protocol gateway, the first system authenticating upon a request of the receiving terminal the access code, and transmitting the converted multimedia message to the receiving terminal through the wireless application protocol gateway.

The first system is preferably a multimedia message service system. The second system is preferably a short message service system. The second system is preferably a wireless application protocol push proxy gateway.

Additional features and advantages of the invention will be set forth in the description which follows, and in part will be apparent from the description, or may be learned by practice of the invention. It is to be understood that both the foregoing general description and the following detailed description of the present invention are exemplary and explanatory and are intended to provide further explanation of the invention as claimed.

These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

Features, elements, and aspects of the invention that are referenced by the same numerals in different figures represent the same, equivalent, or similar features, elements, or aspects in accordance with one or more embodiments.

FIG. 1 illustrates the construction of a system for making a multimedia message service compatible with a non-compatible terminal in accordance with one embodiment of the present invention.

FIG. 2 is a block diagram illustrating construction of an MMS system in accordance with a preferred embodiment of the present invention.

FIG. 3 is a block diagram illustrating the construction of a system for making a multimedia message service compatible with a non-compatible terminal in accordance with an embodiment of the present invention.

FIGS. 4A and 4B are flow charts of a method for making a multimedia message service compatible with a non-compatible MMS terminal in accordance with one embodiment of the present invention.

FIG. 5 is a flow chart for making multimedia message service compatible with a non-compatible terminal in accordance with one embodiment of the present invention.

FIGS. 6A and 6B are conceptual views for transmitting a uniform resource locator and an access code of one embodiment of the present invention.

FIG. 7 is a signal flow chart illustrating implementation of the method described in FIG. 4 of the present invention.

FIG. 8 is a signal flow chart illustrating implementation of the flow chart of FIG. 5 of the present invention.

### DETAILED DESCRIPTION OF THE PREFERRED EMBODIMENTS

The present invention relates to a system and method for making a multimedia message service compatible with non-supported multimedia message service (MMS) terminals.

Although the invention is illustrated with respect to a mobile message service, it is contemplated that the invention may be utilized anywhere it is desired for maintaining electronic support within a mobile communication system to mobile terminals having an incompatible message format.

Reference will now be made in detail to the preferred embodiments of the present invention, examples of which are illustrated in the accompanying drawings.

The system and method provides for transmission of a multimedia message created in a supported MMS terminal to a non-supported MMS terminal. The non-supported MMS terminal receives a uniform resource locator (URL). The URL directs a user to a format converted multimedia message, which may be accessed using a non-supported MMS terminal. An access code is provided for accessing the URL. The access code provides an authentication means to prevent unauthorized users viewing the multimedia message.

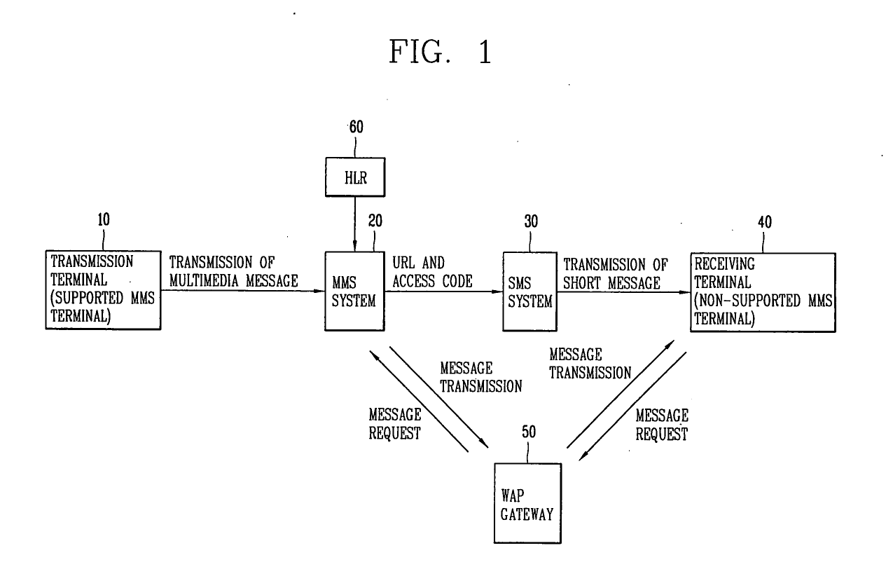

FIG. 1 illustrates the construction of a system for making a multimedia message service compatible with a non-supported MMS terminal in accordance with one embodiment of the present invention.

A transmission terminal 10 having an MMS client transmits a multimedia message created by a sender. A MMS system 20 converts and/or stores the multimedia message in a multimedia message format supported by a receiving terminal 40 if the receiving terminal 40 is the non-supported MMS terminal. The MMS system 20 sends a URL of the converted multimedia message and an access code allowing the receiving terminal 40 to access to the URL.

A short message system (SMS) 30 transmits a short message informing whether the receiving terminal 40 receives the multimedia message, or the URL and the access code for the multimedia message produced by the MMS system 20. The receiving terminal 40 requests the multimedia message by extracting the URL and the access code included in the short message and performs an authentication procedure for accessing the URL. The multimedia message is outputted through a browser mounted in the mobile terminal. A wireless application protocol (WAP) gateway 50 serves as a proxy for a multimedia message request and response between the MMS system 20 and the SMS system 30. A home location register (HLR) 60 stores the specific information of terminals connected by a network.

For the following example, the transmission terminal 10 is a supported MMS terminal and the receiving terminal 40 is a non-supported MMS terminal. The MMS system 20 is a generic name for various devices related to the MMS. The MMS system 20, for example, may include an MMS proxy relay, an MMS relay server and an MMS center (MMSC).

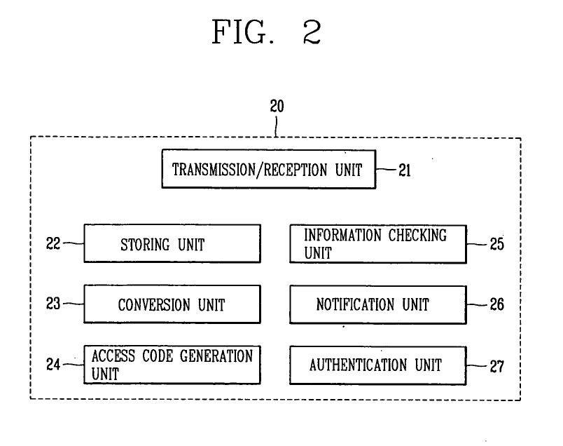

FIG. 2 is a block diagram illustrating construction of an MMS system in accordance with a preferred embodiment of the present invention.

The MMS system 20 includes a transmission/reception unit 21. The transmission/reception unit 21 receives the multimedia message from the MMS-supported transmission terminal 10, checks an address of the receiving terminal 40, and transmits the multimedia message and various types of information to the receiving terminal 40. A conversion unit 23 is provided for converting the multimedia message into a document of a format that can be outputted from a browser of the receiving terminal 40. A storage unit 22 stores the multimedia message and the document that has been converted in the conversion unit 23. An access code generation unit 24 generates an access code for allowing access to a specific URL using a random number generation algorithm or the like and storing the access code. An information monitoring services unit 25 determines the software programs loaded in the receiving terminal 40. A notification unit 26 notifies the receiving terminal 40 of arrival of the multimedia message. An authentication unit 27 performs user authentication to permit access to the URL of the converted multimedia message.

The storage unit 22 includes a first region for storing the multimedia message received from the receiving terminal 40. The storage unit further includes a second region for storing the document converted into a format supported by the non-supported MMS terminal of the multimedia message stored in the first region.

The storage unit 22 stores the received multimedia message and the format-converted multimedia message into different regions. The storage unit 22 can exist as a storing medium outside the MMS system 20 as well as inside of the MMS system 20.

The conversion unit 23 converts the multimedia message into a markup language (ML). For example, the markup language may be a wireless markup language (WML), an extensible hypertext markup language (XHTML), and a compact HTML (CHTML) or other similar format. The conversion unit 23, in one example, converts the multimedia message into a WML document of a form of text/vnd,wap,wml, application/vnd.wap,wlmc, or image/vnd.wap.wbmp.

The information monitoring services unit 25 provides information for observing operating program through monitoring services of an MMS client browser or a multimedia player of the receiving terminal 40.

The authentication unit 27 performs, in this example, an authentication process using information of the receiving terminal 40, such as an inputted identifier, to access the URL of the WML document. The authentication unit 27, in another example, may perform authentication using the information of the non-supported terminal 40 obtained from a mobile station integrated system digital network (MSISDN) or, alternatively, a mobile identification number (MIN). The receiving terminal authenticates the information using at least one the following: a security algorithm and a password input by a receiver that has been previously set to access the MMS system.

The MMS system is requested to transmit a notification message, including the URL and the access code, indicating arrival of the multimedia message through the notification unit 26. The SMS system 30 generates a short message. The short message includes information. The short message is transmitted to the receiving terminal 40. The short message includes a textual inquiry from a receiving terminal 40 in regards to whether to receive the multimedia message or whether to access the URL.

The SMS system 30, in yet another example, before transmission may add the whole or at least a part of the text included in the multimedia message to the short message. The transmission capacity of the short message is limited. If the proposed text in the short message exceeds the capacity limit of the short message, the SMS system 30 separates the short message into several short messages for further transmissions.

The receiving terminal 40 checks whether the multimedia message has arrived. The receiving terminal 40 extracts the URL and the access code of the WML document from the short message. The receiving terminal 40 connects to the URL requesting the multimedia message and implements the multimedia message received through the WAP gateway 50. The receiving terminal 40, in this example, basically includes a browser that capability to read and to write both text and images. The receiving terminal 40 may have a multimedia player for reproducing video.

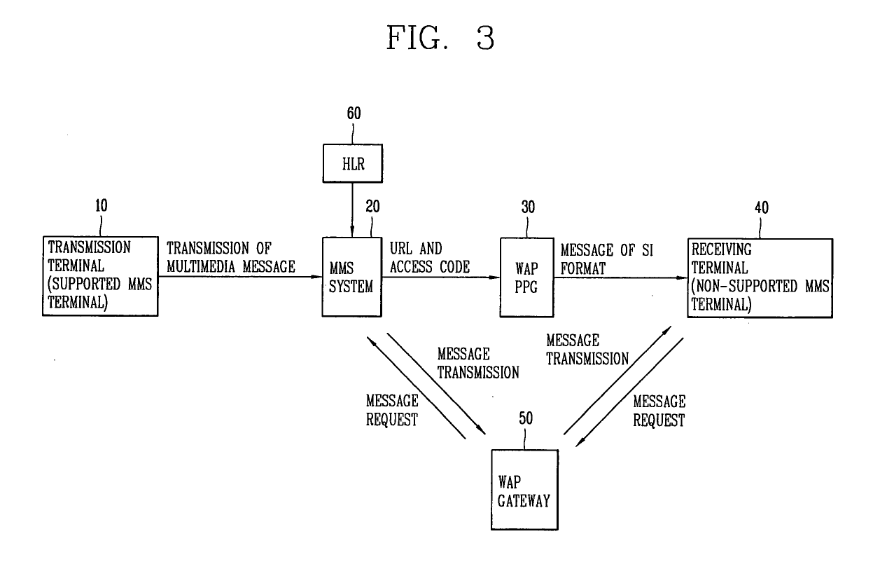

FIG. 3 illustrates construction of a system for making a multimedia message service compatible with a non-supported multimedia terminal utilizing wireless access protocol push proxy gateway (WAP PPG).

Upon transmission by the notification unit 26, see FIG. 2, of a notification message which informs arrival of a multimedia message, or, alternatively, when a request to the MMS system 20 is made for transmission of a message including the URL and the access code, the WAP PPG 80 transmits a message in a service indication (SI) formatted message to the receiving terminal 40. The SI formatted message includes an inquiry whether to receive the multimedia message or the URL.

The WAP PPG 80 preferably transmits the SI formatted message in a connection-originated method. When the message is transmitted in the connection-oriented method, the WAP PPG 80 provides a session connection between the WAP PPG 80 and the receiving terminal 40. The WAP PPG 80 transmits the SI-formatted message. After message transmission, the WAP PPG 80 cuts-off the session connection.

In another example, the message is transmitted in a connection-less method. In this example, the WAP PPG 80 transmits the SI-format message without providing a session connection with the receiving terminal 40.

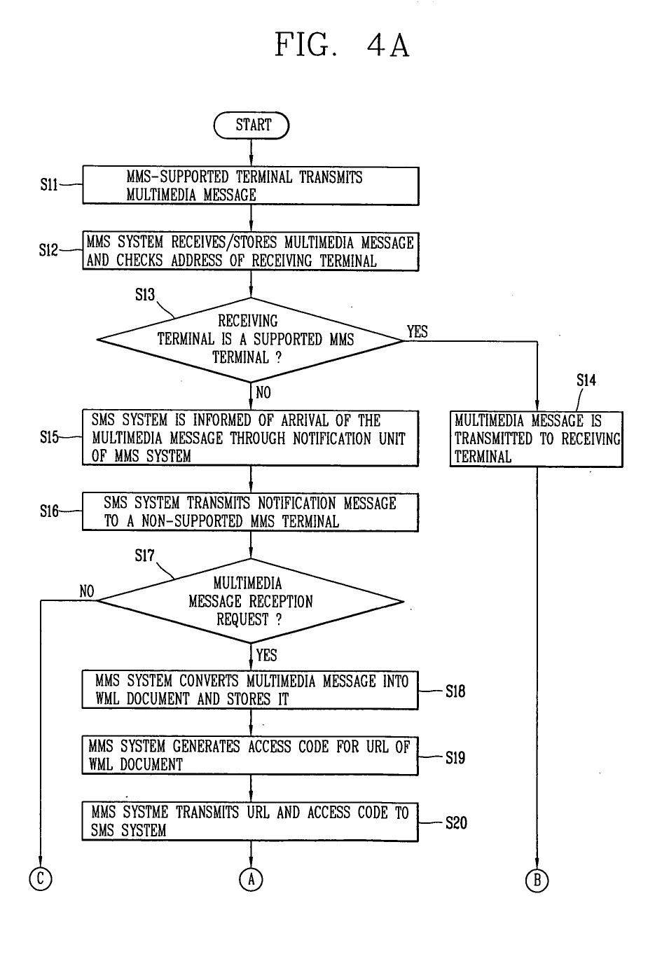

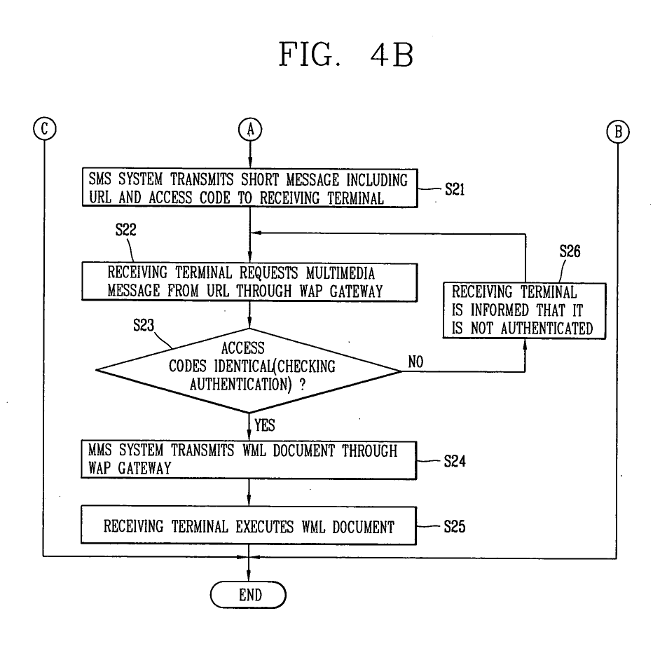

FIGS. 4A and 4B are flow charts of a method for making a multimedia message service compatible with a non-supported MMS terminal in accordance with one embodiment of the present invention.

A sender transmits a multimedia message created in the MMS-supported terminal 10 (S11). The MMS system 20 receives the multimedia message through the transmission/reception unit 21. The MMS system 20 stores the multimedia message in the storage unit 22, and monitors an address, i.e., phone number, of the receiving terminal 40 for receiving the multimedia message through the HLR 60 (S12). The multimedia message may include text, images, video, or audio.

The MMS system 20 monitors the information on the receiving terminal 40 through the information monitoring services unit 25 (S13). The MMS system 20 determines whether the receiving terminal 40 is a supported MMS terminal, or includes supporting programs for a MMS client, non-MMS client, browser, or multimedia player.

The receiving terminal, for example, is a supported MMS terminal and is provided an MMS client supporting implementation of the multimedia message.

If the receiving terminal 40 is the MMS-supported terminal, the MMS system 20 transmits the multimedia message to the receiving terminal 40 (S14). If the receiving terminal 40 is a non-supported MMS terminal, the MMS system 20 informs the SMS system 30 that the multimedia message will be transmitted to the receiving terminal 40 through the notification unit 26 (S15).

The SMS system 30 transmits a notification message informing the existence of the multimedia message to the receiving terminal 40 (S16). In this case, the notification message is a short message including a textual inquiry regarding whether the receiver may receive the multimedia message. The notification message may include a portion of or the whole text of the multimedia message.

Upon checking the notification message, the user, may choose to permit reception of the multimedia message (S17). In this case, the receiving terminal 40 transmits a response message requesting the multimedia message to the MMS system 20 through the WAP gateway 50. The MMS system 20 receives the response message, and converts the multimedia message into a format supported by the receiving terminal 40 through the conversion unit 23. The converted multimedia message is stored in the storage unit 22 (S18). The storage unit 22 includes a region for storing the converted message, and, in this example, an external storage medium outside of the MMS system 20. The conversion unit 23 converts the multimedia message into the WML document.

An access code generation unit 24 generates an access code to a URL where the WML document is stored and stores the result (S19). The MMS system 20 transmits a message including the generated access code and the URL to the SMS system 30 through the transmission/reception unit 21 (S20). The access code generation unit 24 generates a different access code each time by using a random number generation algorithm.

Upon receiving the URL and the access code from the MMS system 20, the SMS system 30 transmits the short message including the URL and the access code to the receiving terminal 40 (S21). When the receiver checks the short message through the receiving terminal 40 and requests access to the URL, the receiving terminal 40 transmits a request message through the WAP gateway 50 as connection to the URL (S22). The request message is a response message including the access code and is automatically transmitted either when the receiver checks or inputs the access code included in the short message, or the receiver checks the short message.

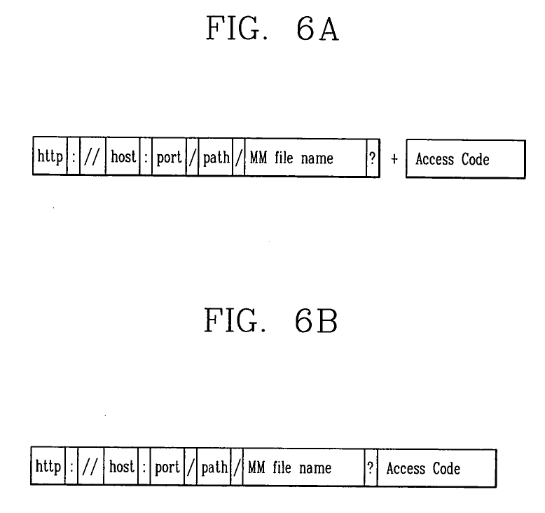

The MMS system 20 separates and transmits the URL and the access code as shown in FIG. 6A, or combines and transmits the URL and the access code as shown in FIG. 6B.

When the receiving terminal is connected to the URL, the MMS system 20 performs an authentication checking procedure on the receiving terminal 40 through the authentication unit 27 (S23). Namely, the MMS system 20 determines whether the access code included in the request message is identical to the access code stored in the authentication unit 27. If the two access codes are identical, the MMS system 20 authenticates the receiving terminal 40. If the access codes are not identical, the MMS system 20 does not authenticate the receiving terminal and informs the receiving terminal 40 (S26).

The authentication checking procedure may be performed in other ways than the method of using the access code. One of the methods to perform authentication is by using specific information such as MSISDN or MIN of the receiving terminal 40. The specific information, for example of the MSISDN or MIN, of the receiving terminal 40, and previous stored specific information in the HLR of the receiving terminal 40 are compared. If the former and latter specific information are identical, the receiving terminal is authenticated. Otherwise, the receiving terminal is not authenticated.

In another embodiment of the authentication checking procedure, the authentication unit 27 performs authentication by using the access code and the specific information of the receiving terminal 40. The access code and the specific information transmitted from the receiving terminal 40 are compared with the access code stored in the authentication unit 27. The specific information is stored in the HLR. If both access codes and specific information are identical, the receiving terminal is authenticated. Otherwise, the receiving terminal is not authenticated.

To perform the authentication checking procedure, a method of authenticating the receiving terminal by comparing a password previously set in the MMS system 20 by the receiver and a password inputted through the receiving terminal by the receiver. A method of authenticating the receiving terminal 40 with information of the receiving terminal 40 transformed by the security algorithm may be used. The authentication unit 27, in another alternative, may authenticate the terminal by combining two or more of the above methods.

Upon the receiving terminal being authenticated, the MMS system 20 transmits the multimedia message stored as the WML document in the URL requested through the WAP gateway 50 to the receiving terminal 40 (S24). Upon receiving the multimedia message, the receiving terminal 40 executes the mounted browser so that the receiver may check the multimedia message (S25). If video is included in the multimedia message, the receiving terminal 40 executes the multimedia player for viewing the video.

A signal transmitted and received between the MMS system 20 and the WAP gateway 50 is a hypertext transfer protocol (HTTP), while a signal transmitted and received between the WAP gateway 50 and the receiving terminal 40 is a wireless session protocol (WSP). The request message is transmitted through the WAP gateway 50 from the receiving terminal 40 to the WAP gateway 50. The request message is converted into the HTTP through the WAP gateway 50, and transmitted to the MMS system 20.

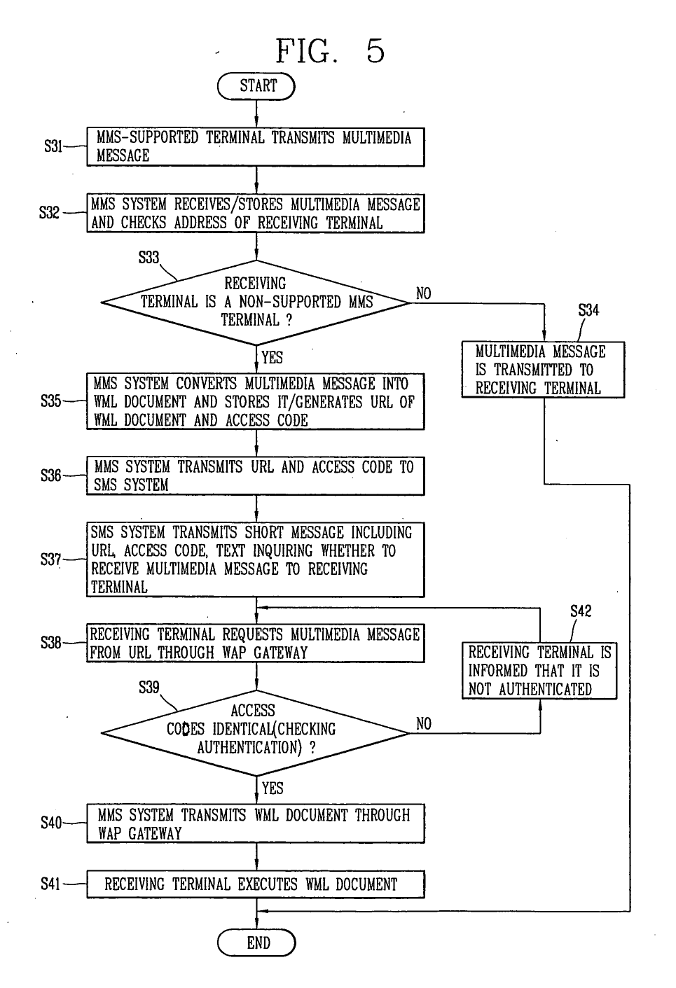

FIG. 5 is a flow chart illustrating a method for making a multimedia message service compatible with a non-supported MMS terminal in accordance with an embodiment of the present invention.

A sender sends the multimedia message created through the supported MMS terminal 10 (S31). The MMS system 20 receives the multimedia message through the transmission/reception unit 21 and stores the multimedia message in the storage unit 22. The MMS system checks an address, or alternatively a phone number, of the receiving terminal 40 for transmission through the HLR 60 of the multimedia message (S32).

The MMS system 20 checks information on the receiving terminal 40 through the information monitoring services unit 25 (S33). The MMS system 20 checks whether the receiving terminal 40 is the MMS-supported terminal or whether a supporting program such as the MMS client, non-MMS client, a browser or a multimedia player is being utilized.

If the receiving terminal 40 is a supported MMS terminal having the MMS client, the MMS system 20 transmits the multimedia message stored in the storage unit 22 to the receiving terminal 40 (S34).

If the receiving terminal 40 is a non-supported MMS terminal that does not have an MMS client, the MMS system 20 converts the multimedia message stored in the storage unit 22 into a format supported by the receiving terminal 40 using the conversion unit 23. The converted message is stored in the storage unit 22 (S35). The multimedia message and the converted message are stored in distinct locations. The conversion unit converts the multimedia message into a WML document.

The access code generation unit 24 generates an access code providing access to a URL for locating the WML document and stores the result (S35). The message generated in the notification unit 26 includes the generated access code and the URL transmitted to the SMS system 30 via the transmission/reception unit 21 (S36). The access code generation unit 24 generates a different access code each time using a random number generation algorithm.

Upon receiving the URL of the WML document and the access code providing access to the URL, the SMS system 30 transmits the URL, the access code, and a text informing that the multimedia message is in a standby transmission mode to the MMS system 20. A short message includes in part or in whole text of the multimedia message transmitted to the receiving terminal 40 (S37). If the size of the text of the multimedia message exceeds a capacity that one short message can transmit, the text may be transmitted as two or more short messages or through two or more transactions.

The receiver checks the short message transmitted to the receiving terminal 40. If the receiver accesses the URL and requests receipt of the multimedia message, the receiving terminal 40 transmits the request message. The request message includes the access code to the MMS system 20 through the WAP gateway 50 utilized to request access to the URL (S38). The request message is transmitted as the WSP between the receiving terminal 40 and the WAP gateway 50, and transmitted as the HTTP between the WAP gateway 50 and the MMS system 20. The request message is a response message automatically transmitted including the access code when the receiver checks and inputs the access code included in the short message or when the receiver checks the short message.

When the receiving terminal is connected to the URL, the MMS system 20 performs an authentication checking procedure on the receiving terminal 40 through the authentication unit 27 (S39). The MMS system 20 determines whether the access code included in the request message is identical to the access code stored in the authentication unit 27. If the two access codes are identical, the MMS system 20 authenticates the receiving terminal 40. However, if the access codes are not identical, the MMS system 20 does not authenticate the receiving terminal and informs the receiving terminal 40 accordingly (S42).

In the case access codes are identical, the MMS system 20 transmits the multimedia message stored as the WML document in the URL requested to be accessed by the receiving terminal 40 to the receiving terminal 40 through the WAP gateway 50 (S40). Upon receiving the multimedia message, the receiving terminal 40 executes the mounted browser so the receiver can check the multimedia message (S41). If video is included in the multimedia message, the receiving terminal 40 executes the multimedia player to reproduce the video.

The embodiments of the method for making multimedia message service compatible, in this example, includes the SMS system 30 transmitting the notification message directly to the receiving terminal as shown in FIG. 1. However, the same principles of the invention may be applied for a case where the notification message is transmitted to the receiving terminal 40 through a WAP PPG 80.

The method for making the multimedia message service compatible by using the WAP PPG 80 is similar to the method for making the multimedia message service compatible by using the SMS system 30. The difference is the fact that the multimedia message has an SI format, in place of the short message, that is provided to the receiving terminal 40.

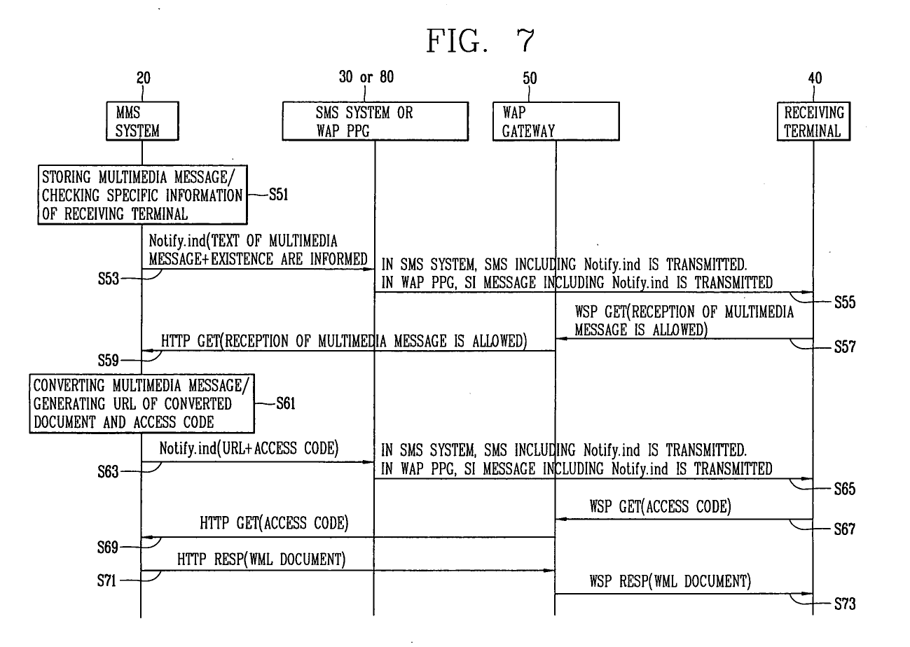

FIG. 7 is a signal flow chart showing implementation of the method of FIG. 4.

After storing the multimedia message and checking the specific information of the receiving terminal 40 (S51), the MMS system 20 transmits notify.ind to the SMS system 30 or the WAP PPG 80 to inform the existence of the multimedia message (S53). The notify.ind includes a part or the whole of the text included in the multimedia message.

The SMS system 50 converts the notify.ind into an SMS format and transmits the converted notify.ind for the receiving terminal 40. The WAP PPG 80 converts the notify.ind into an SI format message and provides the SI format message to the receiving terminal 40 in the connection-oriented method or the connectionless method (S55).

The short message, or the SI message from the SMS system 30 or the WAP PPG 80 is transmitted to the receiving terminal 40. If the receiving terminal 40 receives of the multimedia message, the receiving terminal 40 transmits a WSP GET to the WAP gateway 50 (S57). The WAP gateway 50 converts the WSP GET into HTTP GET and transmits it to the MMS system 20 (S59).

The MMS system 20 converts the multimedia message into a format that can be supported by the receiving terminal 40 (S61), and transmits a URL of the converted document and notify.ind including an access code allowing access to the URL, to the SMS system 30, or the WAP PPG 80 (S63).

The SMS system 30 converts the notify.ind into an SMS format and transmits it to the receiving terminal 40. The WAP PPG 80 converts the notify.ind into an SI formatted message. The SI formatted message is sent to the receiving terminal 40. A short message transmitted by the SMS system 30, or the SI formatted message transmitted by the WAP PPG 80 includes the URL of the converted multimedia message and an access code.

When the receiving terminal 40 receives the short message, the SI message from the SMS system 30, or the WAP PPG 80 and requests access to the URL, the receiving terminal 40 transmits WSP GET. THE WSP GET includes the access code to the WAP gateway 50 (S67). The WAP gateway 50 converts the WSP GET into HTTP GET. THE HTTP GET is transmitted to the MMS system 20 (S69).

Upon receiving the HTTP GET, the MMS system 20 transmits a WML document corresponding to the URL as an HTTP resp to the WAP gateway 50 (S71). The WAP gateway 50 converts the HTTP resp into a WSP resp and transmits it to the receiving terminal 40 (S73). The WAP gateway 50 converts the HTTP format message into the WSP format message, or the WSP format message into the HTTP format message and transmits between the MMS system 20 and the non-supported MMS receiving terminal 40.

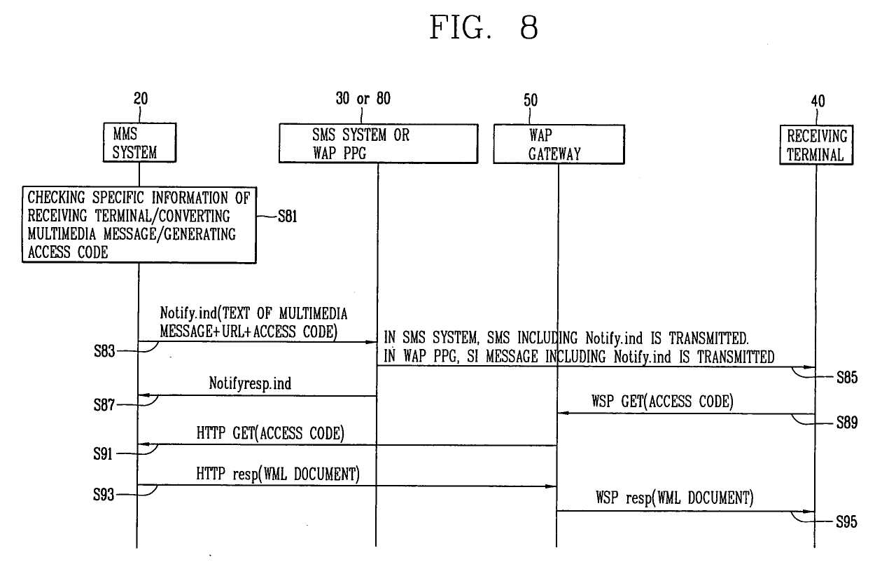

FIG. 8 is a signal flow chart showing implementation of the method of FIG. 5.

The MMS system 20 receives the multimedia message from the transmission terminal and checks the specific information of the receiving terminal 40. If the receiving terminal 40 is the non-supported MMS terminal, the MMS system 20 converts the multimedia message into the WML document and stores it. The MMS system produces an access code allowing access to the WML document (S81).

The MMS system 20 transmits the URL of the WML document and the access code, and a part or the whole of the text of the multimedia message to the SMS system 30 or the WAP PPG 80 (S83). The SMS system 30, or the WAP PPG 80 transmits the short message, or the SI formatted message to the receiving terminal 40 (S85).

When the receiving terminal 40 requests access to the URL of the WML document, the receiving terminal 40 transmits the WSP GET including the access code to the WAP gateway 50 (S89). The WAP gateway 50 converts the WSP GET into a HTTP GET. The HTTP GET is transmitted to the MMS system 20 (S91).

Upon receiving the HTTP GET, the MMS system 20 transmits the WML document corresponding to the URL as the HTTP resp to the WAP gateway 50 (S93). The WAP gateway 50 converts the HTTP resp into the WSP resp. The WAP gateway 50 transmits the WSP resp to the receiving terminal 40 (S95). More specifically, the WAP gateway 50 converts the HTTP format message into the WSP format message. In another example, the WAP gateway 50 converts the HTTP format message in the WSP format message. The converted message is sent from the MMS system 20 and the non-supported MMS receiving terminal 40.

The system and method for making the multimedia message service compatible for a non-supported MMS terminal enhances a user's convenience checking multimedia messages.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

Although the present invention is described in the context of a mobile terminal, the present invention may also be used in any wired or wireless communication systems using mobile devices, such as PDAs and laptop computers equipped with wired and wireless communication capabilities. Moreover, the use of certain terms to describe the present invention should not limit the scope of the present invention to certain type of wireless communication system, such as UMTS. The present invention is also applicable to other wireless communication systems using different air interfaces and/or physical layers, for example, TDMA, CDMA, FDMA, WCDMA, etc.

1. A system for making a multimedia message service compatible with a non-supported multimedia message terminal, the system comprising:
a first system for converting a format of a multimedia message and transmitting a uniform resource locator and an access code of the converted multimedia message in response to a receiving terminal being detected as the non-supported multimedia message terminal; and
a second system for receiving the converted multimedia message, and transmitting the uniform resource locator and the access code to the non-supported multimedia message terminal,
wherein the non-supported multimedia message terminal receives the converted multimedia message.

2. The system of claim 1 further comprising:
a wireless application protocol gateway for transmitting a request for the multimedia message and the converted multimedia message between the first system and the non-supported multimedia message terminal.

3. The system of claim 1 further comprising:
a home location register for storing specific information of terminals connected to the first system.

4. The system of claim 3, wherein the specific information comprises:
at least one of a mobile station integrated system digital network and a mobile identification number.

5. The system of claim 1, wherein the first system comprises:
a transmission/reception unit for communicating a multimedia message and information about the multimedia message;
a conversion unit for converting the multimedia message into a format capable of being implemented by the receiving terminal;
a storage unit for storing the multimedia message and the converted multimedia message;
an access code generation unit for generating an access code permitting access to the uniform resource locator of the converted multimedia message and storing the converted multimedia message;
an information monitoring service unit for monitoring programs implemented in the receiving terminal;
a notification unit for informing the receiving terminal regarding arrival of the multimedia message; and
an authentication unit for performing authentication when accessing the uniform resource locator associated with the converted multimedia message.

6. The system of claim 5, wherein the storage unit comprises:
a first region for storing the multimedia message received from a transmission terminal; and
a second region for storing the converted multimedia message.

7. The system of claim 5, wherein the storage unit is an external storage medium outside the first system.

8. The system of claim 5, wherein the access code generation unit generates a different access code every time by using a random number generation algorithm.

9. The system of claim 5, wherein the authentication unit performs authentication of the receiving terminal by one of:
comparing an access code transmitted from the receiving terminal and a previously stored access code located in the access code generation unit;
comparing specific information of the receiving terminal and previously stored specific information in a home location register;
comparing a password previously set by a receiver in the first system and a password inputted through the receiving terminal; and
transforming the specific information of the receiving terminal using a security algorithm.

10. The system of claim 1, wherein the first system is a multimedia message service system.

11. The system of claim 1, wherein the second system is a short message service system.

12. The system of claim 11, wherein the short message service system transmits a short message including the uniform resource locator of the converted multimedia message and the access code.

13. The system of claim 12, wherein the short message comprises at least one of: a text notifying arrival of the multimedia message, a textual inquiry regarding accessing the uniform resource locator, and at least one portion of text included in the multimedia message.

14. The system of claim 1, wherein the second system is a wireless access protocol push proxy gateway.

15. The system of claim 14, wherein the wireless access protocol push proxy gateway provides a service indication message to the receiving terminal, and the service indication message includes the uniform resource locator of the converted multimedia message and the access code.

16. The system of claim 15, wherein the short information message comprises at least one of a text notifying arrival of the multimedia message, a textual inquiry whether to access to the URL, and at least one portion of text included in the multimedia message.

17. The system of claim 1, wherein the first system is a transmission terminal which is a supported multimedia message service terminal.

18. The system of claim 1, wherein the receiving terminal is a non-supported multimedia message service terminal.

19. A method for making a multimedia message service compatible for transmitting a multimedia message to a receiving terminal, the method comprising:
determining if the receiving terminal is an non-supported multimedia message terminal;
converting a multimedia message by a first system into a format supportable in the receiving terminal in response to the receiving terminal being detected as a non-supported multimedia message terminal;
informing the receiving terminal of a uniform resource locator and an access code of the converted multimedia message through a second system;
the receiving terminal requesting the multimedia message stored in the uniform resource locator through a wireless application protocol gateway;
the first system authenticating the access code upon a request of the receiving terminal; and
transmitting the converted multimedia message to the receiving terminal through the wireless application protocol gateway.

20. The method of claim 19, wherein the first system is a multimedia message service system.

21. The method of claim 19, wherein the second system is a short message service system.

22. The method of claim 19, wherein the second system is a wireless application protocol push proxy gateway.

23. The method of claim 19, wherein informing the receiving terminal of the uniform access locator and the access code further comprises:
the receiving terminal checking specific information about the first system;
the first system producing the access code allowing access to the uniform resource locator of the converted multimedia message;
the first system transmitting the uniform resource locator and the access code to the second system; and
the second system transmitting the uniform resource locator and the access code in a certain message to the receiving terminal through the second system.

24. The method of claim 23, wherein converting the multimedia message by the first system into a format supportable in the receiving terminal further comprises:
transmitting the multimedia message through the second system;
the second system transmitting a notification of arrival of the multimedia message which originated from the first system to the receiving terminal; and
the receiving terminal transmitting a request through the wireless access protocol gateway for the multimedia message.

25. The method of claim 23, wherein the certain message is a short message if the second system is a short message service system.

26. The method of claim 23, wherein the certain message has a service information format if the second system is a wireless access protocol push proxy gateway.

27. The method of claim 19, wherein the converted multimedia message is transmitted to the receiving terminal through the wireless application protocol gateway in response to successful completion of authentication of the uniform resource locator.

28. The method of claim 27, wherein authenticating by the first system comprises:
determining whether the access code and a previously stored access code in the first system are identical;
verifying if the access code and the previously stored access code are identical; and
informing the receiving terminal if the access code and the previously stored access code are not identical.

29. The method of claim 19 further comprising:
activating a certain browser within the multimedia message of the receiving terminal receiving the converted multimedia message; and
implementing the multimedia message through the certain browser.

30. A method for making a multimedia message service compatible to a receiving terminal not supported by the multimedia message service, the method comprising:
a first system receiving a multimedia message from a transmission terminal and checking information of the receiving terminal;
the first system informing a second system regarding arrival of a multimedia message through a notification unit if the receiving terminal is a non-supported multimedia message service terminal;
the second system informing the receiving terminal of arrival of the multimedia message by using a certain message;
the first system receiving a reception request for the multimedia message from the receiving terminal through a wireless access protocol gateway;
the first system transforming the multimedia message into a format that is supported by the receiving terminal by using a transformation unit and generating an access code allowing access to a uniform resource locator of the transformed multimedia message through an access code generation unit;
the first system transmitting the uniform resource locator of the transformed multimedia message and the access code to the second system;
the second system transmitting the uniform resource locator of the multimedia message and the access code as a certain message to the receiving terminal;
connecting the receiving terminal to the uniform resource locator through the wireless access protocol gateway;
the receiver terminal authenticating the first system utilizing the access code; and
first system transmitting the multimedia message to the receiving terminal through the wireless access protocol gateway in response to successful completion of the authentication.

31. The method of claim 30, wherein the checking of the information of the receiving terminal further comprises:
checking specific information of the receiving terminal through a home resource register; and
checking a program implemented in the receiving terminal through an information monitoring services unit of the first system.

32. The method of claim 30, wherein the first system is a multimedia message service system.

33. The method of claim 30, wherein the certain message transmitted by the second terminal is a short message if the second terminal is a short message service system.

34. The method of claim 30, wherein the certain message transmitted by the second terminal has a short information format if the second terminal is a wireless access protocol push proxy gateway.

35. The method of claim 30, wherein informing the receiving terminal further comprises notifying arrival of at least one portion of a text of the multimedia message that has been transmitted.

36. The method of claim 30, wherein transmitting the uniform resource locator of the multimedia message as a certain message to the receiving terminal further comprises a textual inquiry whether the received multimedia message is to be transmitted to the receiving terminal.

37. A method for making a multimedia message service compatible with terminals not supported by multimedia, the method comprising:
a first system receiving a multimedia message from a transmission terminal and checking information of a receiving terminal;
transforming the multimedia message to a format supported by the receiving terminal through a transformation unit;
generating an access code allowing access to a uniform resource locator of the transformed multimedia message through an access code generation unit in response to the receiving terminal being determined a non-supported multimedia message service terminal.
the first system transmitting the uniform resource locator of the converted multimedia message and the access code to a second system;
the second system transmitting the uniform resource locator and the access code as a certain message to the receiving terminal;
connecting the receiving terminal to the uniform resource locator through a wireless access protocol gateway and the first system performing authentication of the receiving terminal using the access code; and
the first system transmitting the multimedia message to the receiving terminal through the wireless access protocol gateway when the authentication is completed.

38. The method of claim 37, wherein checking the information of the receiving terminal comprises:
checking specific information of the receiving terminal through an home resource locator; and
checking programs implemented in the receiving terminal through an information monitoring services unit.

39. The method of claim 37, wherein the first system is a multimedia message service system.

40. The method of claim 37, wherein the certain message transmitted by the second terminal is a short message if the second terminal is a short message service system.

41. The method of claim 37, wherein the certain message transmitted by the second terminal is a message of a short information format if the second terminal is a wireless access protocol push proxy gateway.

42. The method of claim 37, wherein transmitting the uniform resource locator and the access code to the receiving terminal comprises a textual inquiry whether to receive the multimedia message and whether at least one portion of a text of the multimedia message are to be additionally transmitted.
